(19) United States
(12) Patent Application Publication
(10) Pub. No.: US 2010/0232013 A1
(43) Pub. Date: Sep. 16, 2010

(54) INFRARED IMAGING LENS SYSTEM AND IMAGE CAPTURE DEVICE HAVING SAME

(75) Inventors: CHUN-YI YIN, Tu-Cheng (TW); CHUN-HSIANG HUANG, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/430,130

(22) Filed: Apr. 27, 2009

(30) Foreign Application Priority Data
Mar. 10, 2009 (CN) 200910300785.3

(51) Int. Cl. G02B 13/14

(52) U.S. Cl. 359/356

(57) ABSTRACT

An infrared imaging lens system includes, in the order from the object side to the image side thereof, a first lens with negative refractive power, a second lens with positive refractive power and a third lens with positive refractive power. The infrared imaging lens system satisfies the following formulas:

−0.65<F/F1<−0.55,

0.52<F/F2<0.62,

0.3<|F/F3|<0.6,

where F1, F2 and F3 are the focal lengths of the first lens, the second lens and the third lens correspondingly, and F is the focal length of the infrared imaging lens system.

### BACKGROUND

1. Technical Field

The present disclosure relates to imaging lens systems and, particularly, to an infrared imaging lens system and an image capture device having the same.

2. Description of Related Art

Infrared image capture devices are now in great demand. Current infrared image capture devices typically include an image capture device for visible light photography and an infrared bandpass filter interleaved in the light path of the image capture device. These infrared image capture devices typically fail to form high-quality images since the image capture device is designed to correct aberrations for visible light, not infrared light.

Therefore, it is desirable to provide an infrared imaging lens system and an image capture device having the same which can overcome the above-mentioned problems.

### BRIEF DESCRIPTION OF THE DRAWINGS

FIG. 1 is a schematic view of an infrared imaging lens system in accordance with an embodiment.

FIGS. 2-4 are graphs respectively showing spherical aberration, field curvature, and distortion occurring in the infrared imaging lens system in accordance with a first exemplary embodiment.

FIGS. 5-7 are graphs respectively showing spherical aberration, field curvature, and distortion occurring in the infrared imaging lens system in accordance with a second exemplary embodiment.

### DETAILED DESCRIPTION

Embodiments of the disclosure will now be described in detail with reference to the drawings.

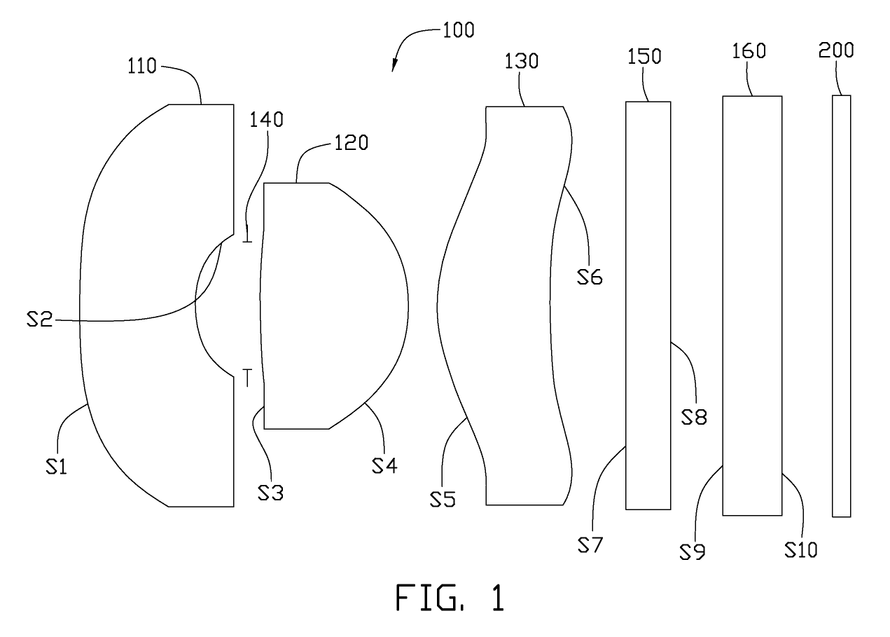

Referring to FIG. 1, an infrared imaging lens system 100 according to an embodiment, in the order from the object side to the image side thereof, includes a first lens 110 with negative refractive power, a second lens 120 with positive refractive power, and a third lens 130 with positive refractive power.

The infrared imaging lens system 100 is employed in an image capture device having a housing (not shown), and an imaging sensor 200 is mounted on the housing for capturing image(s). Light reflected or radiated from an object enters into the infrared imaging lens system 100, travels through the lenses 110, 120, 130 and converges on the imaging sensor 200.

The first lens 110 is a meniscus lens with a convex object-side surface S1 and a concave image-side surface S2. The second lens 120 is a double-convex lens with a convex object-side surface S3 and a convex image-side surface S4. The third lens 130 is a meniscus lens with a convex object-side surface S5 and a concave image-side surface S6.

To minimize the aberrations of the infrared imaging lens system 100 with respect to infrared light, the infrared imaging lens system 100 satisfies the following formulas:

−0.65<F/F1<−0.55, (1)

0.52<F/F2<0.62, (2)

0.3<|F/F3|<0.6, (3)

where F1, F2 and F3 are the focal lengths of the first to third lenses 110, 120, 130 correspondingly, and F is the focal length of the infrared imaging lens system 100.

Formula (1) is for distributing a proper proportion of the optical power of the infrared imaging lens system 100 to the first lens 110, so as to reduce spherical and comatic aberrations and distortion of the infrared imaging lens system 100 with respect to near infrared light (wave band: 750 nm-3000 nm). Additionally, formula (1) ensures a proper back focal length, such that other optics of the infrared imaging lens system 100 can be accommodated between the third lens 130 and the imaging sensor 200.

Formula (2) and (3) distribute proper proportions of the optical power of the infrared imaging lens system 100 to the second and third lenses 120, 130 correspondingly, so as to correct the spherical and comatic aberrations and distortion generated by the first lens 110.

In addition, the infrared imaging lens system 100 satisfies the formula: (4) R1/R2>5, where R1 and R2 are corresponding radiuses of curvature of the object-side surface S1 and image-side surface S2 of the first lens 110. Formula (4) enhances the refractive ability of the first lens 110 to increase the field of view of the infrared imaging lens system 100.

Furthermore, the infrared imaging lens system 100 satisfies the formula: (5) 0.15<F/TTL<0.25, where TTL is the distance along the optical axis of the imaging lens system 100 from the object-side surface S1 of the first lens 110 to the imaging sensor 200. Formula (5) helps minimizing the overall length of the infrared imaging lens system 100.

In this embodiment, the infrared imaging lens system 100 further includes an aperture stop 140, an infrared bandpass filter 150 and a cover glass 160. The aperture stop 140 is interposed between the first lens 110 and the second lens 120 to prevent off-axis light rays from entering the second lens 120, and, as a result, corrects comatic aberration of the infrared imaging lens system 100. The infrared bandpass filter 150 and the cover glass 160 are arranged, in the order from the object side to the image side of the infrared imaging lens system 100, between the third lens 130 and the imaging sensor 200. The infrared bandpass filter 150 is configured for passing infrared light while filtering out visible light. The cover glass 160 is configured for protecting the imaging sensor 200. The optical surfaces of the infrared bandpass filter 150 and the cover glass 160 are referenced by symbols S7 to S10, in the order from the object side to the image side.

In this embodiment, all the lenses in the infrared imaging lens system 100 are aspherical lenses. The aspheric surfaces thereof are shaped according to the formula:

$$x = \frac{{ch}^{2}}{1 + \sqrt{1 - ( k + 1 ) {c}^{2} {h}^{2}}} + \sum {Aih}^{i}$$

where h is a height from the optical axis of the infrared imaging lens system 100 to the aspheric surface, c is a vertex curvature, k is a conic constant, and Ai are i-th order correction coefficients of the aspheric surfaces.

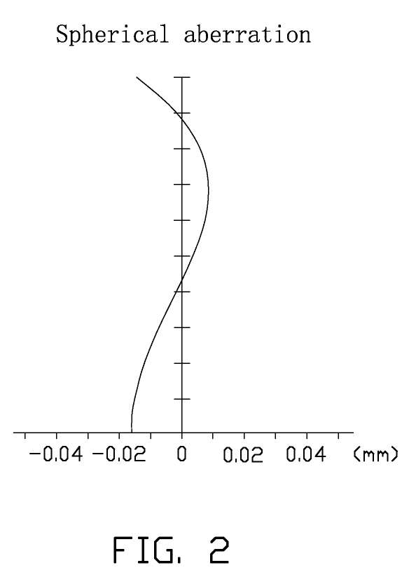

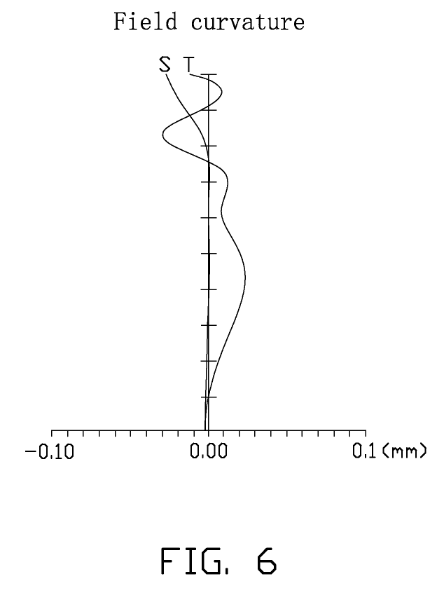

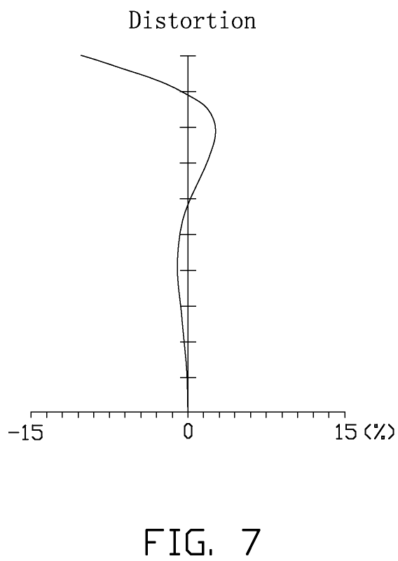

Detailed examples of the imaging lens system 100 are given below with references to the accompanying drawings FIGS. 2-7, but it should be noted that the imaging lens system 100 is not limited to these examples. Listed below are the symbols used in the detailed examples:

2ω: view field angle;

F_{No}: F number;

TTL: total length of the infrared imaging lens system 100;

R: radius of curvature;

D: distance between two adjacent lens surfaces along the optical axis of the infrared imaging lens system 100;

Nd: refractive index of lens; and

V: Abbe constant.

### EXAMPLE 1

Tables 1 and 2 show the lens data of the example 1, wherein 2ω=112°, F_{NO.}=2.0, TTL=4.287 mm, F=0.93 mm, F1=−1.572 mm, F2=1.637 mm, and F3=2.085 mm.

TABLE 1

| Surface | R (mm) | d (mm) | Nd | V |
|---|---|---|---|---|
| S1 | 10 | 0.775912 | 1.531131 | 55.7539 |
| S2 | 0.738769 | 0.364342 | | |
| Aperture stop | ∞ | 0.069267 | | |
| S3 | 4.139481 | 1 | 1.531131 | 55.7539 |
| S4 | −0.98854 | 0.190775 | | |
| S5 | 1.008203 | 0.761124 | 1.531131 | 55.7539 |
| S6 | 10 | 0.226116 | | |
| S7 | ∞ | 0.3 | 1.5168 | 64.167 |
| S8 | ∞ | 0.1 | | |
| S9 | ∞ | 0.4 | 1.5168 | 64.167 |
| S10 | ∞ | 0.1 | | |

TABLE 2

| Surface | k | A4 | A6 | A8 |
|---|---|---|---|---|
| S1 | 3.027046 | 0.211674 | −0.08327 | 0.030071 |
| S2 | 1.014563 | 0.846835 | −0.23387 | 3.279997 |
| S3 | −189.763 | 0.129209 | −0.31282 | 0.324387 |
| S4 | −0.3914 | −0.52926 | 0.299387 | −0.02297 |
| S5 | −5.41414 | 0.069683 | −0.05911 | −0.00526 |
| S6 | 37.19753 | 0.266025 | −0.22247 | 0.037592 |

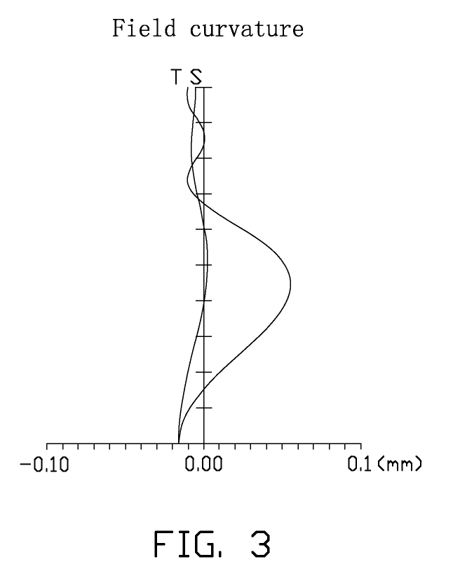

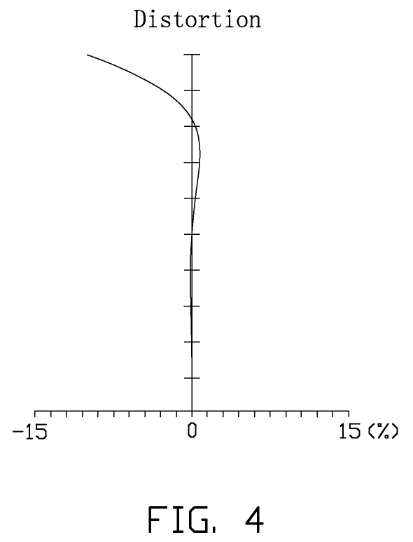

All curves illustrated in FIGS. 2-4 are obtained under the condition that light having wavelength 940 nm is applied to the infrared imaging lens system 100 with the coefficients listed in Example 1. FIG. 2 illustrates the spherical aberration curve of the infrared imaging lens system 100. The spherical aberration of the infrared imaging lens system 100 of Example 1 is from −0.02 mm to 0.02 mm. In FIG. 3, the curves t and s represent tangential field curvature and sagittal field curvature correspondingly. The field curvature occurring in the infrared imaging lens system 100 of Example 1 approximately ranges from −0.02 mm to 0.06 mm. In FIG. 4, the distortion of the infrared imaging lens system 100 of Example 1 is from −12% to 3%.

### EXAMPLE 2

Tables 3 and 4 show the lens data of the example 2, wherein 2ω=121.6°, F_{NO.}=2.0, TTL=4.4 mm, F=0.775 mm, F1=−1.213 mm, F2=1.372 mm, and F3=2.286 mm.

TABLE 3

| Surface | R (mm) | d (mm) | Nd | V |
|---|---|---|---|---|
| S1 | 10 | 0.915297 | 1.531131 | 55.7539 |
| S2 | 0.576519 | 0.5065 | | |
| Aperture stop | ∞ | 0.043291 | | |
| S3 | 2.577315 | 1 | 1.531131 | 55.7539 |
| S4 | −0.85969 | 0.181537 | | |
| S5 | 1.065721 | 0.692025 | 1.531131 | 55.7539 |
| S6 | 7.782754 | 0.160421 | | |
| S7 | ∞ | 0.3 | 1.5168 | 64.167 |
| S8 | ∞ | 0.1 | | |
| S9 | ∞ | 0.4 | 1.5168 | 64.167 |
| S10 | ∞ | 0.1 | | |

TABLE 4

| Sur- | | | | | |
|---|---|---|---|---|---|
| face | k | A4 | A6 | A8 | A10 |
| S1 | −109.044 | 0.167728 | −0.03708 | 0.00253 | 0.004621 |
| S2 | 0.393899 | 0.259018 | 9.640614 | −56.4877 | 188.0098 |
| S3 | −51.4818 | 0.293901 | −0.53909 | 0.441964 | 0.398552 |
| S4 | −0.61408 | −0.45532 | 0.510045 | 0.124043 | −0.09342 |
| S5 | −6.42281 | −0.01779 | 0.067174 | −0.00447 | −0.02032 |
| S6 | 38.30694 | −0.14326 | 0.187266 | −0.05695 | −0.01475 |

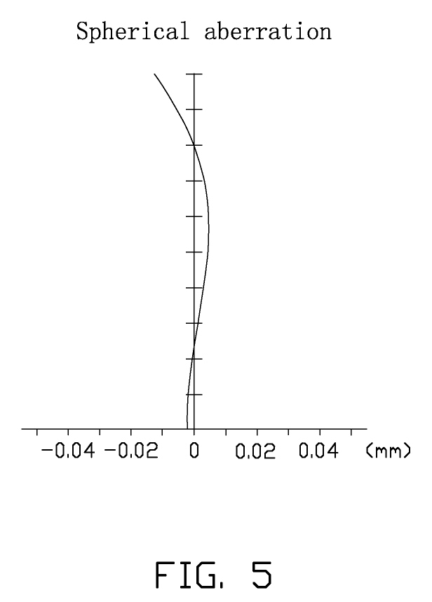

Similar to Example 1, all curves illustrated in FIGS. 5-7 are obtained under the condition that light having wavelength 940 nm is applied to the infrared imaging lens system 100 with the coefficients listed in Example 2. The spherical aberration of the infrared imaging lens system 100 of Example 2 is from −0.02 mm to 0.01 mm. The field curvature of the infrared imaging lens system 100 of Example 2 is from −0.04 mm to 0.03 mm. The distortion of the infrared imaging lens system 100 of Example 2 is from −12% to 3%.

Referring to Examples 1 and 2, the spherical aberration, the field curvature and the distortion of the infrared imaging lens system 100 with respect to infrared light are minimized to acceptable ranges correspondingly. Furthermore, a wide view field angle and a short total length of the infrared imaging lens system 100 are achieved.

It is to be understood, however, that even though numerous characteristics and advantages of the present embodiments have been set forth in the foregoing description, together with details of the structures and functions of the embodiments, the disclosures are illustrative only, and changes may be made in detail, especially in matters of arrangement of parts within the principles of the invention to the full extent indicated by the broad general meaning of the terms in which the appended claims are expressed.

What is claimed is:

1. An infrared imaging lens system comprising, in the order from the object side to the image side thereof:
a first lens with negative refractive power;
a second lens with positive refractive power; and
a third lens with positive refractive power,
wherein the infrared imaging lens system satisfying the following formulas:
−0.65<F/F1<−0.55,
0.52<F/F2<0.62,
0.3<|F/F3|<0.6,
where F1, F2 and F3 are the focal lengths of the first lens, the second lens and the third lens correspondingly, and F is the focal length of the infrared imaging lens system.

2. The infrared imaging lens system as claimed in claim 1, further satisfying the formula R1/R2>5, where R1 and R2 are corresponding radiuses of curvature of the object-side surface and image-side surface of the first lens.

3. The infrared imaging lens system as claimed in claim 1, further satisfying the formula 0.15<F/TTL<0.25, where TTL is the distance along the optical axis of the imaging lens system from the object-side surface of the first lens to an imaging sensor.

4. The infrared imaging lens system as claimed in claim 1, further comprising an aperture stop interposed between the first lens and the second lens.

5. The infrared imaging lens system as claimed in claim 1, further comprising an infrared bandpass filter interposed between the third lens and an imaging sensor; the infrared bandpass filter being configured for passing infrared light while filtering out visible light.

6. The infrared imaging lens system as claimed in claim 5, further comprising a cover glass interposed between the infrared bandpass filter and the imaging sensor.

7. The infrared imaging lens system as claimed in claim 1, wherein all the lenses are aspherical lenses.

8. An image capture device comprising:
a housing;
an imaging sensor mounted in the housing; and
an infrared imaging lens system mounted in the housing and configured for forming an image on the imaging sensor, comprising, in the order from the object side to the image side:
a first lens with negative refractive power;
a second lens with positive refractive power; and
a third lens with positive refractive power,
wherein the infrared imaging lens system satisfying the following formulas:
−0.65<F/F1<−0.55,
0.52<F/F2<0.62,
0.3<|F/F3|<0.6,
where F1, F2 and F3 are the focal lengths of the first lens, the second lens and the third lens correspondingly, and F is the focal length of the infrared imaging lens system.

9. The image capture device as claimed in claim 8, wherein the infrared imaging lens system further satisfies the formula R1/R2>5, where R1 and R2 are corresponding radiuses of curvature of the object-side surface and image-side surface of the first lens.

10. The image capture device as claimed in claim 8, wherein the infrared imaging lens system further satisfies the formula 0.15<F/TTL<0.25, where TTL is the distance along the optical axis of the imaging lens system from the object-side surface of the first lens to the imaging sensor.

11. The image capture device as claimed in claim 8, wherein the infrared imaging lens system further comprises an aperture stop interposed between the first lens and the second lens.

12. The image capture device as claimed in claim 8, wherein the infrared imaging lens system further comprises an infrared bandpass filter interposed between the third lens and an imaging sensor; the infrared bandpass filter being configured for passing infrared light while filtering out visible light.

13. The image capture device as claimed in claim 12, wherein the infrared imaging lens system further comprises a cover glass interposed between the infrared bandpass filter and the imaging sensor.

14. The image capture device as claimed in claim 8, wherein all the lenses are aspherical lenses.
